(19) United States
(12) Patent Application Publication
(10) Pub. No.: US 2003/0041190 A1
(43) Pub. Date: Feb. 27, 2003

(54) System and method for efficiently performing a command swapping procedure

(75) Inventor: Praveen K. Kolli, Sunnyvale, CA (US)

Correspondence Address: Gregory J. Koerner, SIMON & KOERNER LLP, Suite B, 10052 Pasadena Avenue, Cupertino, CA, 95014, US

(73) Assignee: Sony Corporation and Sony Electronics, Inc.

(21) Appl. No.: 09/886,583

(22) Filed: Jun. 21, 2001

(51) Int. Cl. G06F 13/36

(52) U.S. Cl. 710/38; 710/310

(57) ABSTRACT

A system and method for efficiently performing a command swapping procedure may preferably include a processor configured to generate commands corresponding to various peripheral devices in an electronic system. A command queue may receive the foregoing commands from the processor, and may responsively store the commands into a FIFO memory device that may be configured to temporarily store the commands in a series of sequential memory locations. The peripheral devices may then repeatedly access the commands from a first location of the FIFO memory device when the corresponding peripheral devices are ready to execute the commands. Swap logic from the command queue may advantageously exchange a delayed command corresponding to a busy peripheral device, and substitute a non-delayed command for a non-busy peripheral device into the first location of the FIFO memory device to thereby permit the non-delayed command to be executed in a more expeditious and efficient manner.

### BACKGROUND SECTION

1. Field of the Invention

This invention relates generally to techniques for system management techniques, and relates more particularly to a system and method for efficiently performing a command swapping procedure.

2. Description of the Background Art

Implementing efficient methods for managing systems is a significant consideration for designers and manufacturers of contemporary electronic devices. However, efficiently managing systems of electronic devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced system operations may provide additional benefits to a system user, but may also place increased demands on the control and management of various device components. For example, an enhanced electronic device that transfers digital image data may benefit from an effective implementation because of the large amount and complexity of the digital data involved.

In certain contemporary environments, complex or lengthy data transfer operations may often consume substantial amounts of available system resources to the detriment of other system functionalities. For example, a system may be delayed from performing other important tasks if frequently required to perform one or more data transfer operations of significant complexity or length.

Due to growing demands on system resources and substantially increasing data magnitudes, it is apparent that developing new techniques for systems management is a matter of concern for related electronic technologies. Therefore, for all the foregoing reasons, developing efficient systems for managing systems remains a significant consideration for designers, manufacturers, and users of contemporary electronic devices.

### SUMMARY

In accordance with the present invention, a system and method are disclosed for efficiently performing a command swapping procedure in an electronic system. In one embodiment, initially, a CPU may preferably issue a series of commands which may be temporarily stored into a FIFO in a command queue of the electronic system. In certain embodiments, swap logic in the command queue may responsively examine an enable register to determine whether to perform one or more of the following command swapping procedures discussed below.

If command swapping procedures are enabled, the swap logic from the command queue may preferably utilize any suitable techniques to determine the current state of peripheral devices associated with the commands in the FIFO. For example, in one embodiment, the swap logic may preferably set a current swap location to equal a value of one. The current swap location may preferably correspond to any particular location of the FIFO.

Next, the swap logic may preferably determine whether a peripheral device corresponding to the particular command in the first location of the FIFO is currently in a busy state. The swap logic may preferably determine whether the foregoing peripheral device is in a busy state by utilizing any effective technique. For example, the swap logic may monitor peripheral status lines from respective peripheral interfaces that each correspond to a different peripheral device in the electronic system.

If the swap logic determines that the peripheral device corresponding to the command in the first location of the FIFO is not currently in a busy state, then that peripheral device may preferably access and execute the command from the first location of the FIFO. The command queue may then update the remaining commands in the FIFO by moving each command forward by one location in the direction of the first location (to thereby refill the first location of the FIFO). The command swapping procedure may then preferably return to evaluate the current state of the peripheral device that corresponds to the new command in the first location of the FIFO.

However, if the swap logic determines that the peripheral device corresponding to the original command in the first location of the FIFO is currently in a busy state, then the swap logic may preferably increment the current swap location of the FIFO by a value of one. Then, the swap logic may preferably determine whether the peripheral device corresponding to the command in the current swap location of the FIFO is currently in a busy state.

In various embodiments, the swap logic may utilize any suitable mechanism to sequentially examine locations of the FIFO to determine whether a peripheral device associated with a particular command is currently in a busy state. Therefore, the foregoing technique of incrementing a current swap location is presented as an example for purposes of illustration.

If the swap logic determines that the peripheral device corresponding to the current swap location of the FIFO is not currently in a busy state, then the swap logic may preferably perform a command swapping procedure to exchange the non-delayed command in the current swap location of the FIFO with the delayed command in the first location of the FIFO.

The swap logic may then preferably determine whether more commands are present in the FIFO, and if additional commands are present, then the present invention may preferably return to perform additional command swapping procedures when appropriate. However, if no additional commands are present in the FIFO, then the foregoing command swapping procedure may preferably terminate. The present invention thus provides an improved system and method for efficiently performing a command swapping procedure.

### BRIEF DESCRIPTION OF THE DRAWINGS

FIG. 1 is a block diagram for one embodiment of an electronic system, in accordance with the present invention;

FIG. 2 is a block diagram for one embodiment of the bridge device of FIG. 1, in accordance with the present invention;

FIG. 3 is a block diagram for one embodiment of the memory of FIG. 1, in accordance with the present invention;

FIG. 4 is block diagram for one embodiment of the CPU interface of FIG. 2, in accordance with the present invention;

FIG. 5 is a block diagram for one embodiment of the command queue of FIG. 4, in accordance with the present invention;

FIG. 6 is a block diagram for one embodiment of an exemplary command, in accordance with the present invention;

FIG. 7 is a diagram illustrating an exemplary level one command swap, in accordance with one embodiment of the present invention;

FIG. 8 is a diagram illustrating an exemplary level two command swap, in accordance with one embodiment of the present invention;

FIG. 9 is a block diagram illustrating a level two command swap transfer, in accordance with one embodiment of the present invention; and

FIG. 10 is a flowchart of method steps for performing a command swapping procedure, in accordance with one embodiment of the present invention.

### DETAILED DESCRIPTION

The present invention relates to an improvement in system management techniques. The following description is presented to enable one of ordinary skill in the art to make and use the invention and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for efficiently performing a command swapping procedure in an electronic system, and preferably includes a processor that may preferably be configured to generate commands corresponding to various peripheral devices in the electronic system. A command queue may preferably receive the foregoing commands from the processor, and may responsively store the commands into a FIFO memory device that may be configured to temporarily store the commands in a series of sequential memory locations.

The peripheral devices may then repeatedly access the commands from a first location of the FIFO memory device when the corresponding peripheral devices are ready to execute the commands. Swap logic from the command queue may advantageously exchange a delayed command corresponding to a busy peripheral device, and may substitute a non-delayed command for a non-busy peripheral device into the first location of the FIFO memory device to thereby permit the non-delayed command to be executed in a more expeditious and efficient manner.

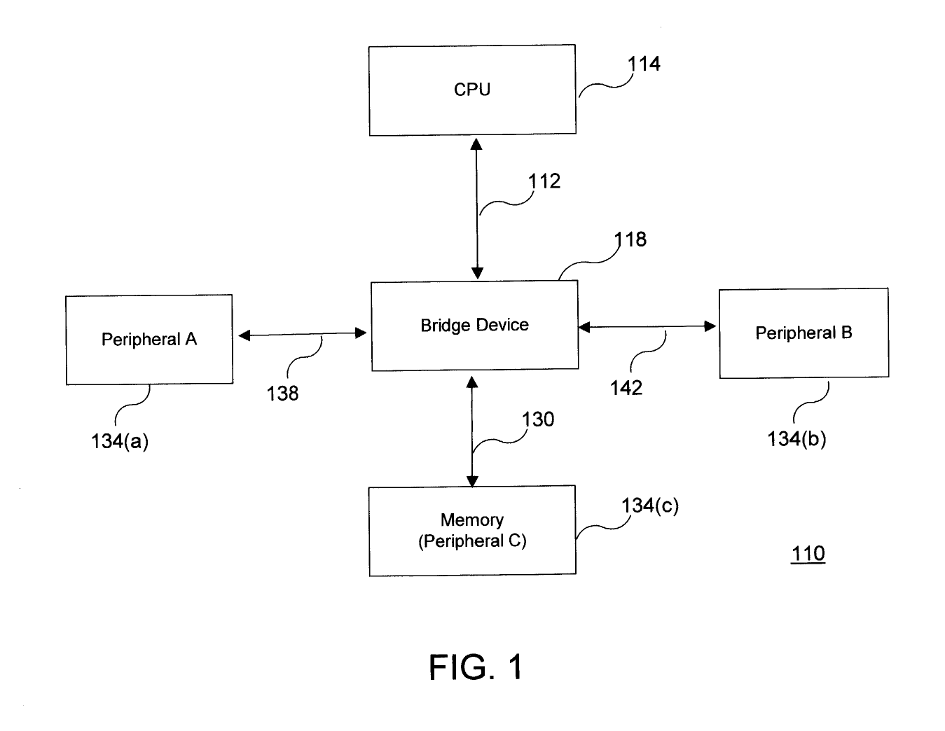

Referring now to FIG. 1, a block diagram for one embodiment of an electronic system 110 is shown, in accordance with the present invention. In the FIG. 1 embodiment, electronic system 110 may preferably include, but is not limited to, a central processing unit (CPU) 114, a bridge device 118, a peripheral A 134(a), a peripheral B 134(b), and a memory 134(c) which may also be referred to herein as peripheral C 134(c). In alternate embodiments, electronic system 110 may readily include various other elements or functionalities in addition to, or instead of, those elements or functionalities discussed in conjunction with the FIG. 1 embodiment. Furthermore, electronic system 110 may be implemented and configured in any desired manner. For example, electronic system 110 may be implemented as one or more integrated circuit devices, as a audio/visual electronic device, as a consumer electronics device, as a portable electronic device, or as a computer device.

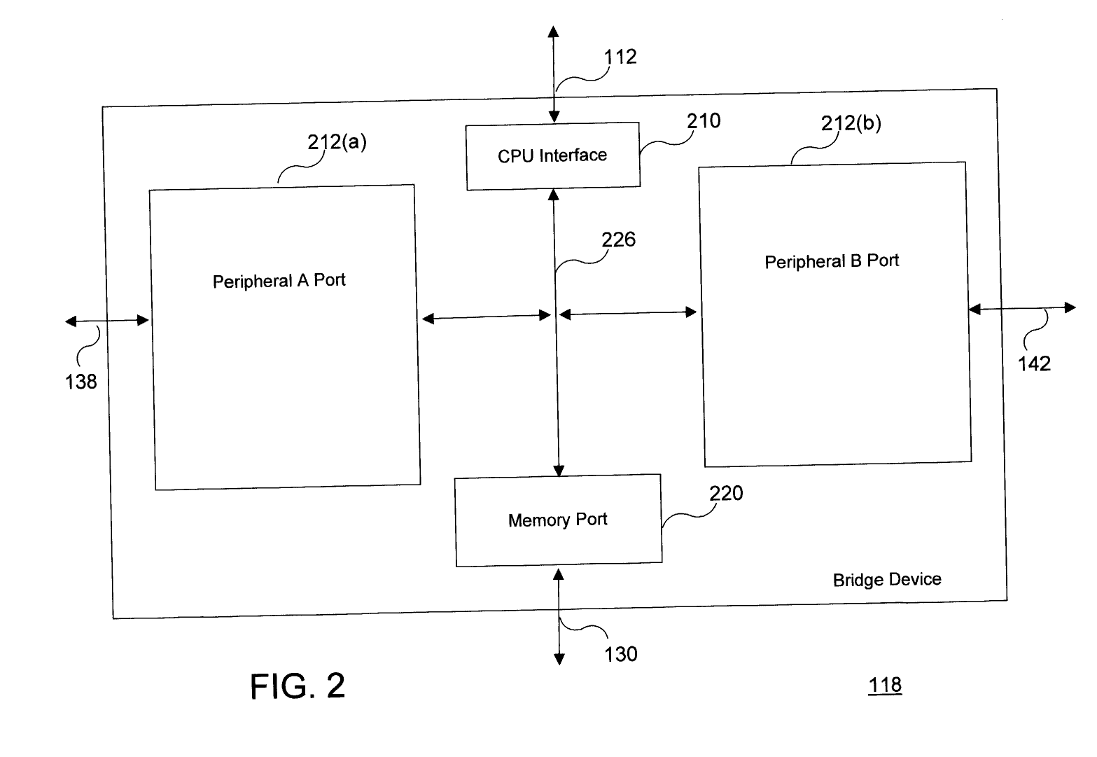

In the FIG. 1 embodiment, CPU 114 may preferably be implemented as any appropriate and effective processor device or microprocessor to thereby control and coordinate the operation of electronic system 110 in response to various software program instructions. Bridge device 118 may communicate with CPU 114 via path 112, and may preferably include one or more port interfaces for bidirectionally communicating with other devices or entities in electronic system 110. One embodiment of bridge device 118 is further discussed below in conjunction with FIG. 2.

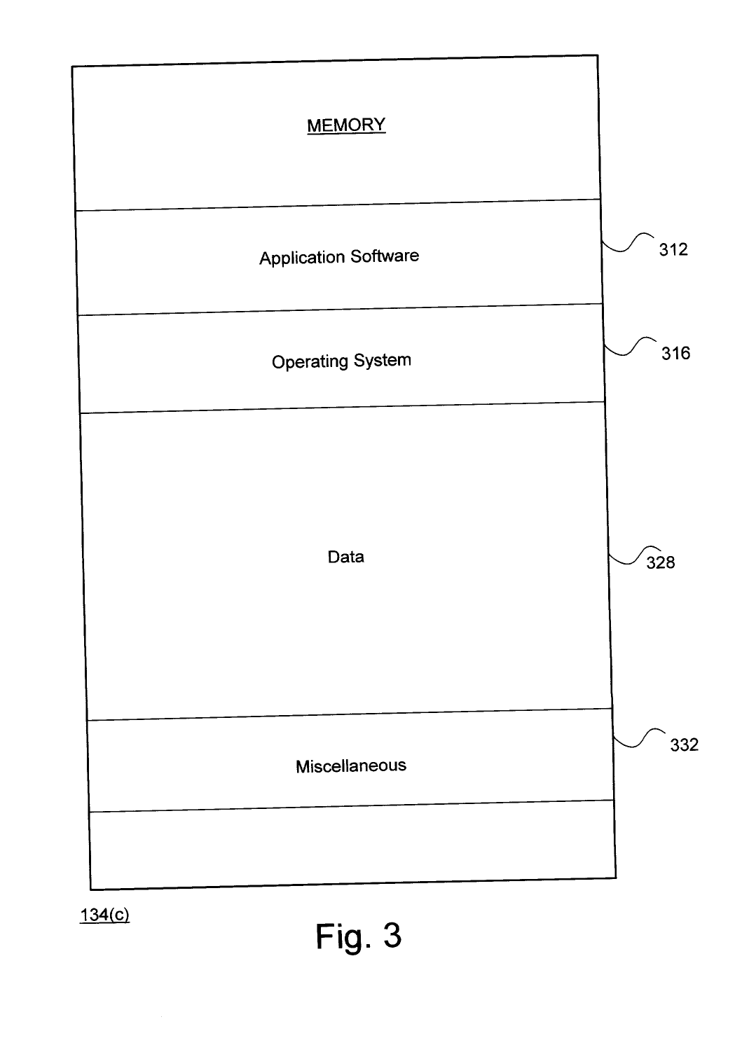

In the FIG. 1 embodiment, memory 134(c) may bidirectionally communicate with bridge device 118 via path 130. Memory 134(c) may be implemented by utilizing any desired technologies or configurations. For example, in certain embodiments, memory 134(c) may preferably be implemented as a memory device that is optimized for performing block transfers of various data. One implementation and configuration for memory 134(c) is further discussed below in conjunction with FIG. 3.

In accordance with the present invention, bridge device 118 may also bidirectionally communicate with various peripheral devices in electronic system 110. In the FIG. 1 embodiment, bridge device 118 may preferably communicate with a peripheral A 134(a) via path 138, and may also preferably communicate with a peripheral B 134(b) via path 142. In alternate embodiments, bridge device 118 may readily communicate with any desired number of peripheral devices in addition to, or instead of, those peripheral devices 134 that are presented and discussed in conjunction with the FIG. 1 embodiment.

Referring now to FIG. 2, a block diagram for one embodiment of the FIG. 1 bridge device 118 is shown, in accordance with the present invention. In the FIG. 2 embodiment, bridge device 118 may preferably include, but is not limited to, a CPU interface 210, a peripheral A port 212(a), a peripheral B port 212(b), and a memory port 220. In alternate embodiments, bridge device 118 may readily include various other elements or functionalities in addition to, or instead of, those elements or functionalities discussed in conjunction with the FIG. 2 embodiment. In addition, bridge device 118 may be implemented in any appropriate manner. For example, in certain embodiments, bridge device 118 may be implemented as a separate integrated circuit device in electronic system 110.

In the FIG. 2 embodiment, CPU 114 may communicate with bridge device 118 through a CPU interface 210. Similarly, memory 134(c) may communicate with bridge device 118 through a memory port 220. In addition, peripheral A 134(a) may communicate with bridge device 118 through a peripheral A port 212(a), and peripheral B 134(b) may communicate with bridge device 118 through a peripheral B port 212(b). Bridge device 118 may preferably also include a bridge bus 226 to enable various components and devices in electronic system 110 to effectively communicate through bridge device 118.

Referring now to FIG. 3, a block diagram for one embodiment of the FIG. 1 memory 134(c) is shown, in accordance with the present invention. In the FIG. 3 embodiment, memory 134(c) may preferably include, but is not limited to, application software 312, an operating system 316, data 328, and miscellaneous routines 332. In alternate embodiments, memory 134(c) may readily include various other components in addition to, or instead of, those components discussed in conjunction with the FIG. 3 embodiment.

In the FIG. 3 embodiment, application software 312 may include program instructions that are preferably executed by CPU 114 (FIG. 1) to perform various functions and operations for electronic system 110. The particular nature and functionality of application software 312 may preferably vary depending upon factors such as the type and particular use of the corresponding electronic system 110.

In the FIG. 3 embodiment, operating system 316 preferably controls and coordinates low-level functionality of electronic system 110. Data 328 may preferably be implemented and configured to provide a location for storing any desired type of electronic data or other appropriate information. Miscellaneous routines 332 may include any desired additional software instructions to facilitate corresponding functions performed by electronic system 110.

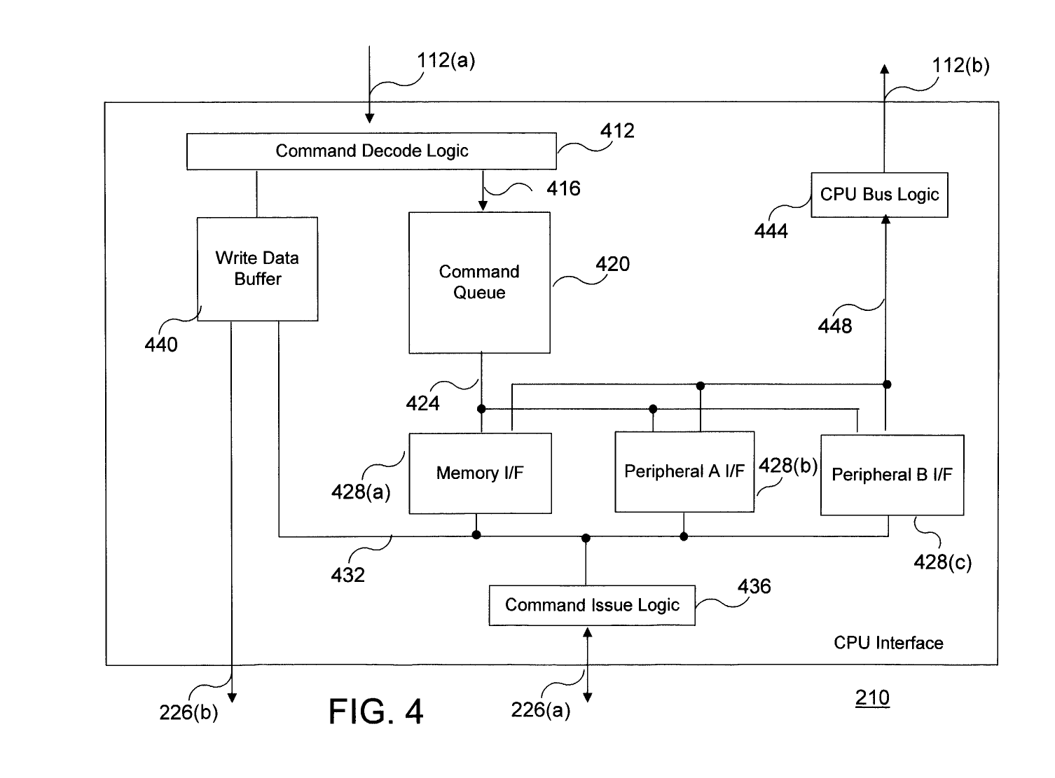

Referring now to FIG. 4, a block diagram for one embodiment of the FIG. 2 CPU interface 210 is shown. In the FIG. 4 embodiment, CPU interface 210 preferably may include, but is not limited to, command decode logic 412, a command queue 420, a memory interface (I/F) 428(a), a peripheral A I/F 428(b), a peripheral B I/F 428(c), command issue logic 436, a write data buffer 440, and CPU bus logic 444. In alternate embodiments, CPU interface 210 may readily include various other elements or functionalities in addition to, or instead of, those elements or functionalities discussed in conjunction with the FIG. 4 embodiment.

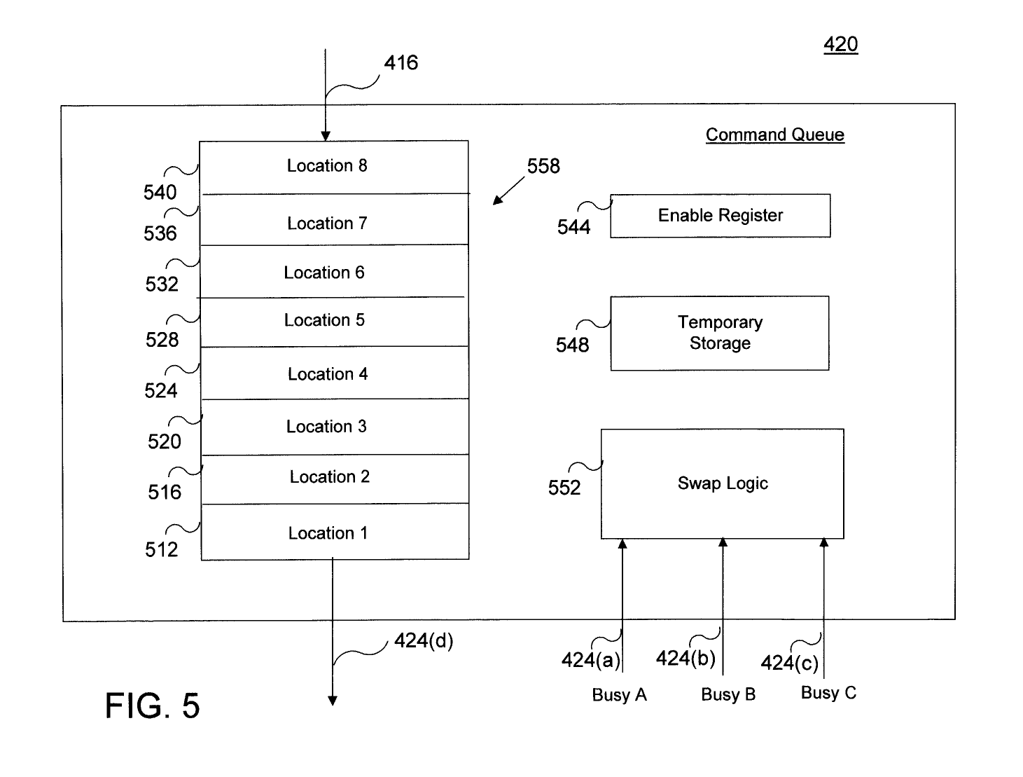

In the FIG. 4 embodiment, CPU 114 (FIG. 1) may preferably send one or more commands to CPU interface 210 for performing various operations in electronic system 110. For example, CPU 114 may send a read data transfer command or a write data command to command decode logic 412 of CPU interface 210. In response, command decode logic 412 may preferably decode and store the foregoing commands into command queue 420 which then may route the commands to an appropriate interface 428 (for example, memory I/F 428(a), peripheral I/F 428(b), or peripheral I/F 428(c)) for transmission through command issue logic 436 to a corresponding peripheral device 134 in electronic system 110. The configuration and utilization of command queue 420 and interfaces 428 are further discussed below in conjunction with FIGS. 5 through 10.

Referring now to FIG. 5, a block diagram for one embodiment of the FIG. 4 command queue 420 is shown, in accordance with the present invention. In the FIG. 5 embodiment, command queue 420 may preferably include, but is not limited to, a first-in-first-out memory (FIFO) 558, an enable register 544, temporary storage 548, and swap logic 552. In alternate embodiments, command queue 420 may readily include various other elements or functionalities in addition to, or instead of, those elements or functionalities discussed in conjunction with the FIG. 5 embodiment. For example, FIFO 558 may be implemented to include any desired number of memory locations.

In the FIG. 5 embodiment, command queue 420 may preferably load commands from CPU 114 into FIFO 558 via path 416 beginning with location 1 (512) and ending with location 8 (540). In the FIG. 5 embodiment, the commands may preferably be sent to peripheral devices 134 from location 1 (512), via path 424(d), and FIFO 558 may then preferably update the contents of each location by moving all commands forward by one location in the direction of location 1 (512) to thereby refill location 1 (512).

In accordance with the present invention, swap logic 552 may preferably monitor peripheral busy lines 424 (for example, busy A 424(a) from memory I/F 428(a), busy B from peripheral A I/F 428(b), or busy C from peripheral I/F 428(c)) to determine whether a particular peripheral device 134 is ready to receive a command from location 1 (512) of FIFO 558. Swap logic 552 may also reference enable register 544 to determine whether a swapping procedure has been enabled by CPU 114. In the FIG. 5 embodiment, enable register 544 may provide separate locations for enabling any desired number of swapping levels.

When a peripheral device 134 in electronic system 110 is unable to currently accept a command from location 1 (512) of FIFO 558, then swap logic 552 may preferably perform a command swapping procedure to relocate the delayed command corresponding to the busy peripheral device 134 to another position in FIFO 558. In the FIG. 5 embodiment, swap logic 552 may preferably utilize temporary storage 548 to perform the foregoing command swapping procedure.

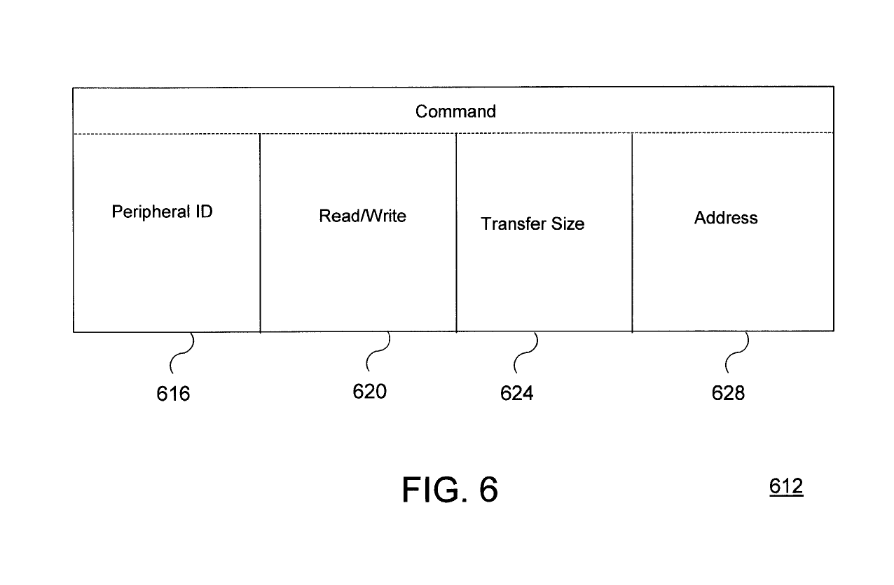

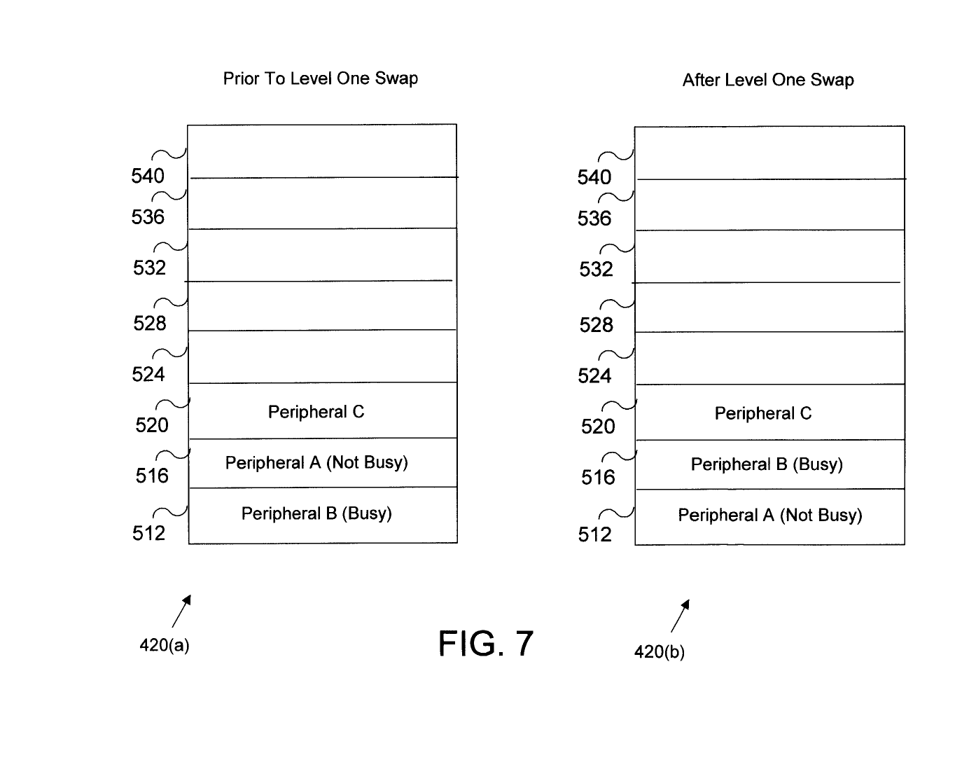

The present invention therefore advantageously allows command queue 420 to continue transmitting commands to non-busy peripheral devices 134, rather than waiting for a particular busy peripheral device 134 to finish a particular task before being able to execute a delayed command from command queue 420. The operation of command queue 420 in performing various command swapping procedures is further discussed below in conjunction with FIGS. 7 through 10. Referring now to FIG. 6, a block diagram for one embodiment of an exemplary command 612 is shown, in accordance with the present invention. In the FIG. 6 embodiment, command structure 512 may preferable include, but is not limited to, a peripheral identifier (ID) 616, a read/write field 620, a transfer size field 624, and an address field 628. In alternate embodiments, command 612 may readily include various other elements or functionalities in addition to, or instead of, those elements or functionalities discussed in conjunction with the FIG. 6 embodiment.

In the FIG. 6 embodiment, swap logic 552 may preferably read peripheral ID 616 to determine the peripheral device 134 with which a particular command 612 corresponds. Peripheral ID 616 may be formatted in any effective manner. Read/write field 620 may preferably include information to designate whether a particular command 612 corresponds to a read data transfer operation or a write data transfer operation. Transfer size field 624 may preferably include information to designation the amount of data associated with a particular command 612. Address field 628 may preferably include an address to designate a memory location corresponding to transfer data for the particular data transfer operation associated with command 612.

Referring now to FIG. 7, a diagram illustrating an exemplary level one command swap is shown, in accordance with one embodiment of the present invention. In the FIG. 7 embodiment, a command queue 420(a) prior to a level one swap in shown. In addition, a command queue 420(b) after a level one swap is also shown. In alternate embodiments, a level one command swap may readily include various other elements or functionalities in addition to, or instead of, those elements or functionalities discussed in conjunction with the FIG. 7 embodiment.

In the FIG. 7 example, prior to a level one command swap, command queue 420(a) may include a peripheral B command for a currently busy peripheral B 134(b) in location one 512. Command queue 420(a) may also include a peripheral A command for a currently non-busy peripheral A 134(a) in location two 516. In addition, command queue 420(a) may include a peripheral C command for a peripheral C 134(c) in location three 520.

Command queue 420(a) may not transmit the peripheral B command for a currently busy peripheral B 134(b) from location one 512 of command queue 420(a) until peripheral B 134(b) enters a non-busy state. Therefore, in order to efficiently continue providing other commands from command queue 420(a) to non-busy peripheral devices 134, swap logic 552 (FIG. 5) may advantageously preferably perform a level one command swap as illustrated in command queue 420(b) of the FIG. 7 example.

In the FIG. 7 example, after the level one command swap, location one 512 of command queue 420(b) may now store the peripheral A command for the currently non-busy peripheral A 134(a) that was formerly in location two 516 of command queue 420(a). In addition, location two 516 of command queue 420(b) may now store the peripheral B command for the currently busy peripheral B 134(b) that was formerly in location one 512 of command queue 420(a). Command queue 420(c) may still include a peripheral C command for a peripheral C 134(c) in location three 520.

Following the foregoing level one command swap, command queue 420 may then immediately transmit the peripheral A command from location one 512 to the currently non-busy peripheral A 134(a) to thereby expedite command execution in electronic system 110. In the FIG. 7 embodiment, command queue 420 may subsequently repeat the foregoing level one command swap with similar or different commands 612 to the same or different peripheral devices 134, in accordance with the present invention.

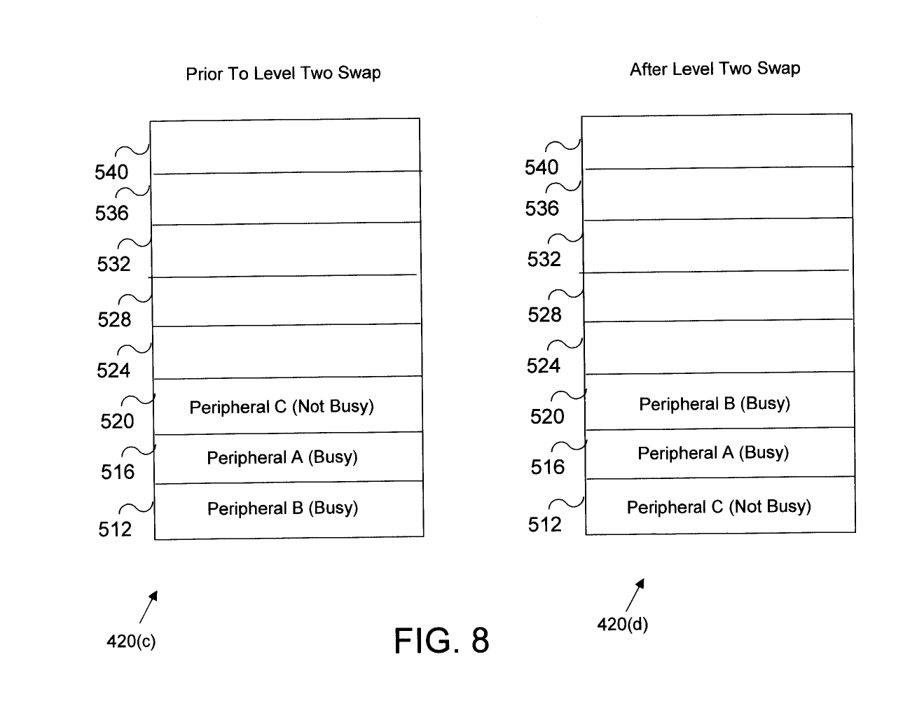

Referring now to FIG. 8, a diagram illustrating an exemplary level two command swap is shown, in accordance with one embodiment of the present invention. In the FIG. 8 embodiment, a command queue 420(c) prior to a level two swap in shown. In addition, a command queue 420(d) after a level two command swap is also shown. In alternate embodiments, a level two command swap may readily include various other elements or functionalities in addition to, or instead of, those elements or functionalities discussed in conjunction with the FIG. 8 embodiment.

In the FIG. 8 example, prior to a level two command swap, command queue 420(c) may include a peripheral B command for a currently busy peripheral B 134(b) in location one 512. Command queue 420(a) may also include a peripheral A command for a currently busy peripheral A 134(a) in location two 516. In addition, command queue 420(a) may include a peripheral C command for a currently non-busy peripheral C 134(c) in location three 520.

Command queue 420(c) may not transmit the peripheral B command for a currently busy peripheral B 134(b) from location one 512 of command queue 420(a) until peripheral B 134(b) enters a non-busy state. In addition, it would not be beneficial for command queue 420(c) to swap the peripheral A command for a currently busy peripheral A 134(a) from location two 516 into location one 512 of command queue 420(a), because command queue 420(c) could not transmit the peripheral A command for the currently busy peripheral A 134(a) from location one 512 until peripheral A 134(a) enters a non-busy state. Therefore, in order to efficiently continue providing other commands from command queue 420(c) to non-busy peripheral devices 134, swap logic 552 (FIG. 5) may advantageously preferably perform a level two command swap as illustrated in command queue 420(d) of the FIG. 8 example.

In the FIG. 8 example, after the level two command swap, location one 512 of command queue 420(d) may now store the peripheral C command for the currently non-busy peripheral C 134(c) that was formerly in location three 520 of command queue 420(c). In addition, location three 520 of command queue 420(d) may now store the peripheral B command for the currently busy peripheral B 134(b) that was formerly in location one 512 of command queue 420(c). Command queue 420(d) may still include a peripheral A command for a busy peripheral A 134(a) in location two 516.

Following the foregoing level two command swap, command queue 420 may then immediately transmit the peripheral C command from location one 512 to the currently non-busy peripheral C 134(c) to thereby expedite command execution in electronic system 110. In the FIG. 8 embodiment, command queue 420 may subsequently repeat the foregoing level two command swap with similar or different commands 612 to the same or different peripheral devices 134, in accordance with the present invention. Furthermore, command swaps between location one 512 and any other location of command queue 420 are equally within the scope of the present invention.

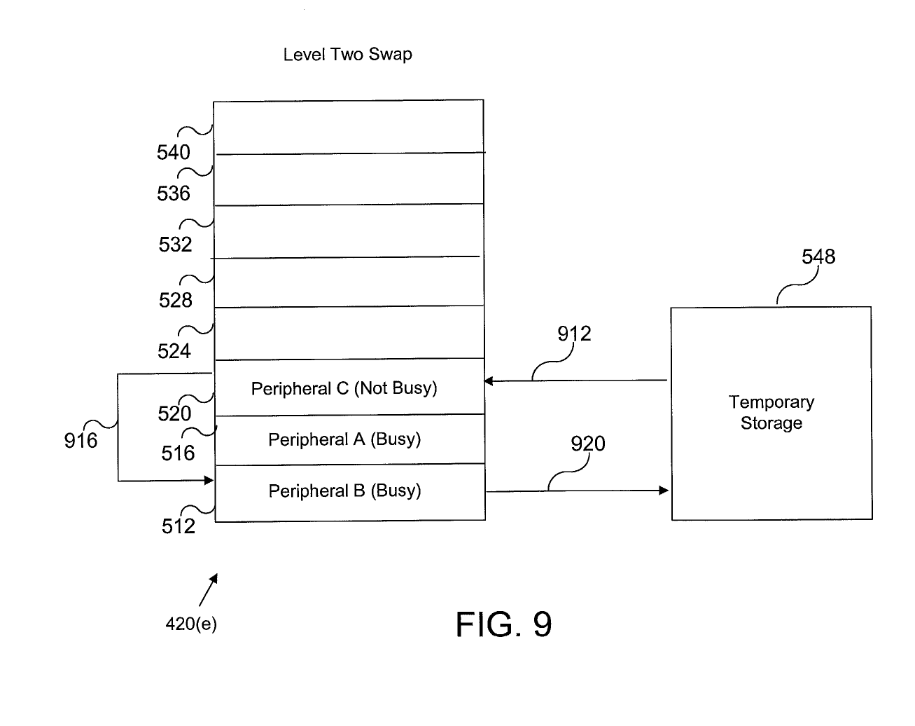

Referring now to FIG. 9, a block diagram illustrating a level two command swap transfer is shown, in accordance with one embodiment of the present invention. In alternate embodiments, a level two command swap transfer may readily utilizes various other elements or functionalities in addition to, or instead of, those elements or functionalities discussed in conjunction with the FIG. 9 embodiment. For example, a transfer mechanism similar to that discussed in conjunction with FIG. 9 may be utilized to perform any level of command swapping, in accordance with the present invention.

In the FIG. 9 embodiment, initially, swap logic 552 may preferably transfer a peripheral B command from location one 512 of command queue 420(e) into temporary storage 548 via path 920. Then, swap logic 552 may preferably transfer a peripheral C command from location three 520 of command queue 420(e) into now-vacant location one 512 of command queue 420(e) via path 916. Finally, swap logic 552 may preferably transfer the peripheral B command from temporary storage 548 into now-vacant location three 520 of command queue 420(e) via path 912. In certain embodiments, when swap logic 552 swaps commands in command queue 420 for a write data transfer operation, then corresponding write data is also swapped in write data buffer 440 (FIG. 4).

In alternate embodiments, instead of performing the foregoing command swapping procedure, it may be beneficial for command queue 420 to send commands to non-busy peripheral devices 134 while still maintaining the original order of the remaining commands in command queue 420. Therefore, in certain alternate embodiments, swap logic 552 may select and transmit commands 612 to non-busy peripheral devices 134 directly from any location of a randomly-accessible memory device by utilizing corresponding addresses or pointers. In addition, in certain other alternate embodiments, swap logic 552 may move selected commands 612 into temporary storage 548 for direct transmission to non-busy peripheral devices 134 without altering the original order of remaining commands 612 in FIFO 558.

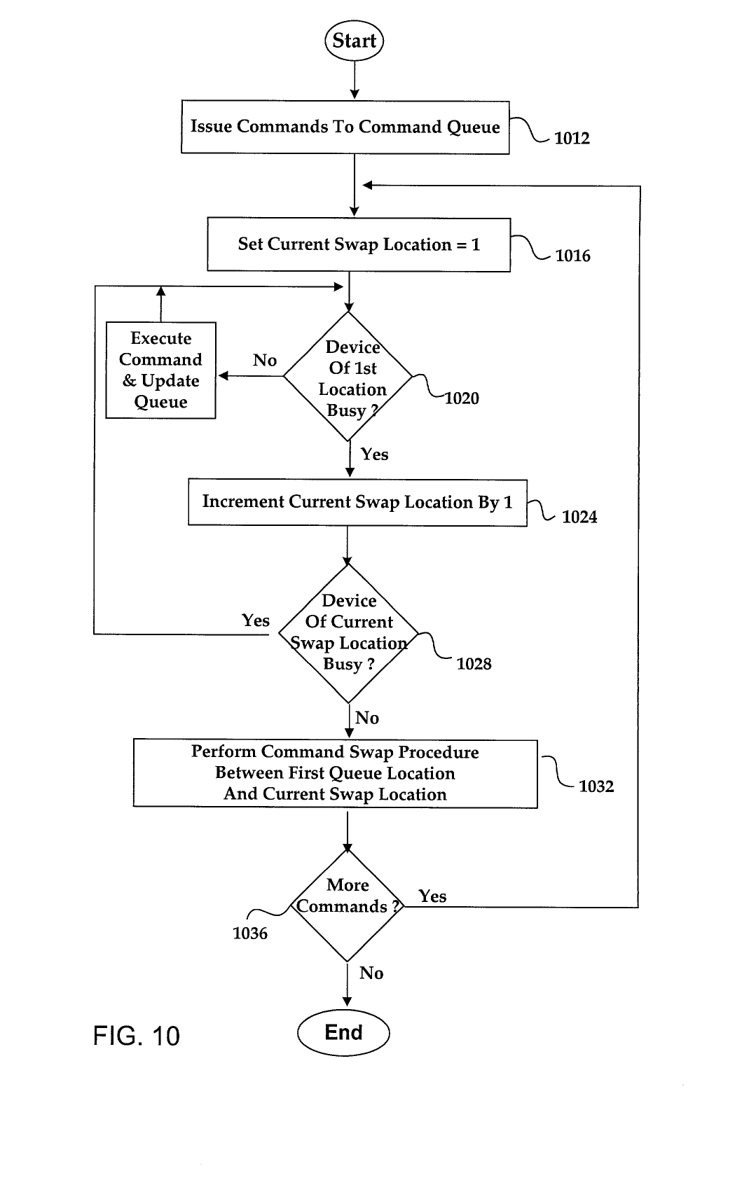

Referring now to FIG. 10, a flowchart of method steps for performing a command swapping procedure is shown, in accordance with one embodiment of the present invention. The FIG. 10 embodiment is presented for purposes of illustration, and in alternate embodiments, the present invention may readily utilize various steps and sequences other than those discussed in conjunction with the FIG. 10 embodiment.

In the FIG. 10 embodiment, initially, in step 1012, CPU 114 may preferably issue a series of commands 612 to a FIFO 558 in a command queue 420 of an electronic system 110. As discussed above in conjunction with FIG. 5, in certain embodiments, command queue 420 may responsively examine an enable register 544 to determine whether to perform one or more of the following command swapping procedures of FIG. 10.

In step 1016, swap logic 552 of the command queue 420 may preferably set a current swap location to equal a value of one. In the FIG. 10 embodiment, the current swap location may preferably correspond to any particular location of FIFO 558. Next, in step 1020, swap logic 552 may preferably determine whether a peripheral device 134 corresponding to the particular command 612 in the first location of FIFO 558 is currently in a busy state. In the FIG. 10 embodiment, swap logic 552 may preferably determine whether the foregoing peripheral device 134 is in a busy state by utilizing any effective technique. For example, swap logic 522 may monitor peripheral status lines 424 from respective peripheral interfaces 428 that each correspond to a different peripheral device 134 in the electronic system 110.

If swap logic 552 determines that the peripheral device 134 corresponding to the command 612 in the first location of FIFO 558 is not currently in a busy state, then that peripheral device 134 may preferably access and execute the command 612 from the first location of FIFO 558. Command queue 420 may then update the remaining commands 612 in FIFO 558 by moving each command 612 forward by one location to thereby refill the first location of FIFO 558. The FIG. 10 process may then preferably return to foregoing step 1020 to evaluate the state of the peripheral device 134 that now corresponds to the new command 612 in location one 512 of FIFO 558.

However, in foregoing step 1020, if swap logic 552 determines that the peripheral device 134 corresponding to the command 612 in the first location of FIFO 558 is currently in a busy state, then in step 1024, swap logic 552 may preferably increment the current swap location of FIFO 558 by a value of one. Then, in step 1028, swap logic 552 may preferably determine whether the peripheral device 134 corresponding to the command 612 in the current swap location of FIFO 558 is currently in a busy state.

In alternate embodiments, swap logic may utilize any suitable mechanism to sequentially examine locations of FIFO 558 to determine whether a peripheral device 134 associated with a particular command is currently in a busy state. Therefore, in the FIG. 10 embodiment, the technique of incrementing a current swap location, as discussed in conjunction with foregoing step 1024, is presented as an example for purposes of illustration.

If swap logic 552 determines that the peripheral device 134 corresponding to the command 612 in the current swap location of FIFO 558 is currently in a busy state, then the FIG. 10 process may preferably return to foregoing step 1020. However, if swap logic 552 determines that the peripheral device 134 corresponding to the current swap location in FIFO 558 is not currently in a busy state, then in step 1032, swap logic 552 may preferably perform a command swap procedure to exchange the non-delayed command 612 in the current swap location of FIFO 558 with the delayed command 612 in location one 512 of FIFO 558. In certain embodiments of the present invention, if multiple commands to the same busy peripheral device 134 are located in adjacent positions in FIFO 558, then swap logic 552 may preferably ensure that the original order of the multiple commands to the busy peripheral device is maintained in FIFO 558 during any command swapping procedures.

In step 1036, swap logic 552 may preferably determine whether more commands are present in FIFO 558. If additional commands are present, then the FIG. 10 process may preferably return to step 1016 to perform additional command swapping procedures when appropriate. However, if no additional commands are present in FIFO 558, then the FIG. 10 process may preferably terminate.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for efficiently performing a command swapping procedure, comprising:
a processor configured to generate commands corresponding to peripheral devices coupled to said system;
a memory device configured to temporarily store said commands in a series of memory locations, said peripheral devices repeatedly accessing said commands from a first location of said memory device when said peripheral devices are ready to execute said commands, said memory device responsively updating said commands in said series of memory locations after each of said commands are accessed from said first location of said memory device; and
swap logic coupled to said memory device for exchanging a delayed command of a busy peripheral device from said first location of said memory device, said swap logic substituting a non-delayed command for a non-busy peripheral device into said first location of said memory device to thereby perform said command swapping procedure.

2. The system of claim 1 wherein said commands include at least one of a read data transfer command and a write data transfer command.

3. The system of claim 1 wherein said memory device is implemented as a first-in-first-out memory for temporarily storing said commands.

4. The system of claim 1 wherein said commands that are not stored in said first location of said memory device cannot be sent to said peripheral devices until a first command in said first location of said memory device is sent to a corresponding one of said peripheral devices to be executed.

5. The system of claim 1 wherein said swap logic receives peripheral device state signals from respective peripheral interface devices that each correspond to a different one of said peripheral devices.

6. The system of claim 1 wherein said system comprises said processor, said peripheral devices including a memory device, and a bridge device that includes peripheral interfaces for respective ones of said peripheral devices, and a command queue that includes said memory device, said swap logic, a temporary storage, and a swap enable register.

7. The system of claim 1 wherein said commands each include a peripheral identifier, a read/write field, a transfer size field, and an address field.

8. The system of claim 1 wherein said processor sends said commands to a command queue that includes said memory device and said swap logic, said memory device being implemented as a FIFO that sequentially stores said commands in said series of memory locations.

9. The system of claim 8 wherein said swap logic examines a swap enable register to determine whether said command swapping procedure is enabled, said swap enable register including enabling locations for separately enabling at least a first level command swap and additional command swaps a different levels, said swap logic performing said command swapping procedure between said delayed command and a lowest-level command corresponding to said non-busy peripheral device.

10. The system of claim 8 wherein said swap logic determines that a peripheral A device corresponding to a command A in said first location of said FIFO is not currently busy by examining a corresponding peripheral A state from a peripheral A interface, said peripheral A interface then responsively sending said command A to said peripheral A device, said FIFO then performing an update procedure to move remaining ones of said commands forward one location toward said first location of said FIFO.

11. The system of claim 8 wherein said swap logic determines that a peripheral A device corresponding to a command A in said first location of said FIFO is currently busy by examining a corresponding peripheral A state from a peripheral A interface, said swap logic then determining whether a peripheral B device corresponding to a command B in said second location of said FIFO is currently busy by examining a corresponding peripheral B state from a peripheral B interface.

12. The system of claim 11 wherein said swap logic determines that said peripheral B device is not currently busy, said swap logic responsively utilizing a temporary storage location to perform a first level command swap procedure in which said command B is moved to said first location of said FIFO, and said command A is moved to said second location of said FIFO.

13. The system of claim 12 wherein said command B is transmitted from said first location of said FIFO to said peripheral B device, said FIFO then performing said update procedure to move said remaining ones of said commands forward said one location toward said first location of said FIFO.

14. The system of claim 11 wherein said swap logic determines that said peripheral B device corresponding to said command B in said second location of said FIFO is currently busy, said swap logic then determining whether a peripheral C device corresponding to a command C in said third location of said FIFO is currently busy by examining a corresponding peripheral C state from a peripheral C interface.

15. The system of claim 14 wherein said swap logic determines that said peripheral C device is not currently busy, said swap logic responsively utilizing said temporary storage location to perform a second level command swap procedure in which said command C is moved to said first location of said FIFO, and said command A is moved to said third location of said FIFO.

16. The system of claim 14 wherein said swap logic determines that said peripheral C device corresponding to said command C in said third location of said FIFO is currently busy, said swap logic then sequentially determining whether additional peripheral devices corresponding to additional commands in higher level locations of said FIFO are currently busy by examining corresponding additional peripheral states from additional peripheral interfaces.

17. The system of claim 16 wherein said swap logic repeats said command swapping procedure in response to each new command in said first location of said FIFO.

18. The system of claim 1 wherein said swap logic stores said delayed command from said first location of said memory device into a temporary storage, moves a non-delayed command from a current swap location into said first location, and then moves said delayed command into said current swap location to complete said command swapping procedure.

19. The system of claim 1 wherein said swap logic maintains an original storage order of said commands in said memory device by selecting and sending said non-delayed command directly from an original location in said memory device to said non-busy peripheral device.

20. The system of claim 1 wherein said swap logic maintains an original storage order of said commands in said memory device by transferring said non-delayed command to a temporary storage, and then transmitting said non-delayed command directly from said temporary storage to said non-busy peripheral device.

21. A method for efficiently performing a command swapping procedure, comprising the steps of:
generating commands corresponding to peripheral devices coupled to said system by utilizing a processor;
storing said commands in a series of memory locations of a memory device;
accessing said commands from a first location of said memory device when said peripheral devices are ready to execute said commands;
updating said commands in said series of memory locations after each of said commands are accessed from said first location of said memory device; and
utilizing swap logic coupled to said memory device to exchange a delayed command of a busy peripheral device from said first location of said memory device, said swap logic substituting a non-delayed command for a non-busy peripheral device into said first location of said memory device to thereby perform said command swapping procedure.

22. The method of claim 21 wherein said commands include at least one of a read data transfer command and a write data transfer command.

23. The method of claim 21 wherein said memory device is implemented as a first-in-first-out memory for temporarily storing said commands.

24. The method of claim 21 wherein said commands that are not stored in said first location of said memory device cannot be sent to said peripheral devices until a first command in said first location of said memory device is sent to a corresponding one of said peripheral devices to be executed.

25. The method of claim 21 wherein said swap logic receives peripheral device state signals from respective peripheral interface devices that each correspond to a different one of said peripheral devices.

26. The method of claim 21 wherein said system comprises said processor, said peripheral devices including a memory device, and a bridge device that includes peripheral interfaces for respective ones of said peripheral devices, and a command queue that includes said memory device, said swap logic, a temporary storage, and a swap enable register.

27. The method of claim 21 wherein said commands each include a peripheral identifier, a read/write field, a transfer size field, and an address field.

28. The method of claim 21 wherein said processor sends said commands to a command queue that includes said memory device and said swap logic, said memory device being implemented as a FIFO that sequentially stores said commands in said series of memory locations.

29. The method of claim 28 wherein said swap logic examines a swap enable register to determine whether said command swapping procedure is enabled, said swap enable register including at least two enabling locations for separately enabling at least a first level command swap and a second level command swap.

30. The method of claim 28 wherein said swap logic determines that a peripheral A device corresponding to a command A in said first location of said FIFO is not currently busy by examining a corresponding peripheral A state from a peripheral A interface, said peripheral A interface then responsively sending said command A to said peripheral A device, said FIFO then performing an update procedure to move remaining ones of said commands forward one location toward said first location of said FIFO.

31. The method of claim 28 wherein said swap logic determines that a peripheral A device corresponding to a command A in said first location of said FIFO is currently busy by examining a corresponding peripheral A state from a peripheral A interface, said swap logic then determining whether a peripheral B device corresponding to a command B in said second location of said FIFO is currently busy by examining a corresponding peripheral B state from a peripheral B interface.

32. The method of claim 31 wherein said swap logic determines that said peripheral B device is not currently busy, said swap logic responsively utilizing a temporary storage location to perform a first level command swap procedure in which said command B is moved to said first location of said FIFO, and said command A is moved to said second location of said FIFO.

33. The method of claim 32 wherein said command B is transmitted from said first location of said FIFO to said peripheral B device, said FIFO then performing said update procedure to move said remaining ones of said commands forward said one location toward said first location of said FIFO.

34. The method of claim 31 wherein said swap logic determines that said peripheral B device corresponding to said command B in said second location of said FIFO is currently busy, said swap logic then determining whether a peripheral C device corresponding to a command C in said third location of said FIFO is currently busy by examining a corresponding peripheral C state from a peripheral C interface.

35. The method of claim 34 wherein said swap logic determines that said peripheral C device is not currently busy, said swap logic responsively utilizing said temporary storage location to perform a second level command swap procedure in which said command C is moved to said first location of said FIFO, and said command A is moved to said third location of said FIFO.

36. The method of claim 34 wherein said swap logic determines that said peripheral C device corresponding to said command C in said third location of said FIFO is currently busy, said swap logic then sequentially determining whether additional peripheral devices corresponding to additional commands in higher level locations of said FIFO are currently busy by examining corresponding additional peripheral states from additional peripheral interfaces.

37. The method of claim 36 wherein said swap logic repeats said command swapping procedure in response to each new command in said first location of said FIFO.

38. The method of claim 31 wherein said swap logic stores said delayed command from said first location of said memory device into a temporary storage, moves a non-delayed command from a current swap location into said first location, and then moves said delayed command into said current swap location to complete said command swapping procedure.

39. The method of claim 21 wherein said swap logic maintains an original storage order of said commands in said memory device by selecting and sending said non-delayed command directly from an original location in said memory device to said non-busy peripheral device.

40. The method of claim 21 wherein said swap logic maintains an original storage order of said commands in said memory device by transferring said non-delayed command to a temporary storage, and then transmitting said non-delayed command directly from said temporary storage to said non-busy peripheral device.

41. A system for efficiently performing a command swapping procedure, comprising:
means for generating commands corresponding to peripheral devices coupled to said system;
means for storing said commands in a series of memory locations of a memory device;
means for accessing said commands from a first location of said memory device when said peripheral devices are ready to execute said commands;
means for updating said commands in said series of memory locations after each of said commands are accessed from said first location of said memory device; and
means for exchanging a delayed command of a busy peripheral device from said first location of said memory device, and substituting a non-delayed command for a non-busy peripheral into said first location of said memory device to thereby perform said command swapping procedure.

42. A system for efficiently executing device commands, comprising: a processor configured to generate commands corresponding to peripheral devices that are coupled to said system; a memory device configured to temporarily store said commands into a series of memory locations; and
swap logic coupled to said memory device for identifying and providing a non-delayed command from said memory device to a non-busy peripheral device.
